(19) United States
(12) Patent Application Publication
(10) Pub. No.: US 2009/0319216 A1
(43) Pub. Date: Dec. 24, 2009

(54) Teaching device and teaching method

(75) Inventor: Taketora Ogata, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/457,443

(22) Filed: Jun. 10, 2009

(30) Foreign Application Priority Data
Jun. 13, 2008 (JP) 2008-155548

(51) Int. Cl. G06F 19/00

(52) U.S. Cl. 702/94

(57) ABSTRACT

Teaching of height of a carrier stage relative to a transfer arm is performed with high accuracy. A teaching device is used when teaching the height of a carrier stage 5 relative to a transfer arm 4 in a transfer system is performed. The transfer system includes the transfer arm 4 that transfers a wafer and the carrier stage 5 with a carrier 1 that holds the wafer mounted thereon. The teaching device includes a teaching jig 10 and a detector 20. The teaching jig 10 includes a disc 11 arranged on a slot base 2 in the carrier 1 and a head member 12 attached to the disc. The head member 12 has a projecting portion designed to be located within an optimal gap between the disc 11 and the transfer arm 4 disposed below the disc 11.

### REFERENCE TO RELATED APPLICATION

This application is based upon and claims the benefit of the priority of Japanese patent application No. 2008-155548, filed on Jun. 13, 2008, the disclosure of which is incorporated herein in its entirety by reference thereto.

The present invention relates to a teaching device and a teaching method used when teaching of the height of a carrier stage relative to a transfer arm in a transfer system is performed. The transfer system includes the transfer arm that transfers a wafer, and the carrier stage with a carrier placed thereon. The carrier holds the wafer.

### FIELD OF THE INVENTION

### Background

In a semiconductor manufacturing process, it is a common practice to take out semiconductor wafers (hereinafter referred to as wafers) laminated and held at predetermined intervals in a carrier on a carrier stage by a transfer arm, perform various processes on surfaces of the wafers for formation of semiconductor elements, and return the wafers to original positions (slots) in the carrier by the transfer arm again. When a relationship of a gap between the transfer arm and a wafer is inappropriate in this practice, abnormal wafer transfer, or a fault of a semiconductor element due to contact of the transfer arm with a wafer surface occurs. For this reason, teaching of the height of the carrier stage relative to the transfer arm becomes important.

In the conventional teaching, adjustment is made to make a gap between the transfer arm and each of wafers above and below the transfer arm uniform, while visually checking the gap (in conventional example 1; refer to FIG. 10). As a method other than a visual check, there is a method of quantifying the gap. As such a method, Patent Document 1 discloses a method of measuring a distance between the transfer arm and a wafer by a non-contact type sensor (a distance measuring unit 212) (in conventional example 2; refer to FIG. 11), a method of using a dial gauge 251 (in conventional example 3; refer to FIG. 12), and a method of using a gap gauge 254 (in conventional example 4; refer to FIG. 13), and a method of using a vernier caliper 256 (in conventional example 5; refer to FIG. 14). Further, Patent Document 1 discloses a method of electrically detecting a contact between a wafer 220E on the arm and one of probes 271A and 271B arranged in a dedicated jig by an electrical resistance measuring unit 272 (tester), and adjusting the arm to a position where the arm comes into contact with neither of the probes 271A and 271B (in conventional example 6; refer to FIG. 15). The probes 271A and 271B are separated by a wafer thickness (or slightly wider than the wafer thickness) above and below the arm.

[Patent Document 1] JP Patent Kokai Publication No. JP-P2007-80960A

### SUMMARY

The disclosure of the above Patent Document 1 is incorporated herein by reference thereto.

An analysis of a related art by the present invention will be given below.

In the teaching by the visual check in conventional example 1 (refer to FIG. 10), the accuracy of the teaching is low. A relationship between a transfer arm 104 and the height of a carrier is inappropriate. Thus, abnormal wafer transfer, or a semiconductor element fault due to contact of a transfer arm 104 with a wafer surface occurs.

In adjustment using the non-contact type sensor (distance measuring unit 212) in conventional example 2 (refer to FIG. 11), accuracy with respect to the gap can be ensured. However, the cost of the system is high. Further, the size of the distance measuring unit 212 is large, so that measurement with a wide span within a carrier (wafer cassette) (which is necessary for measuring slots in upper and lower stages and obtaining an optimal position for each slot) cannot be made.

In the method of using the dial gauge (indicated by reference numeral 251 in FIG. 12) in conventional example 3 (refer to FIG. 12) and the method of using the vernier caliper (indicated by reference numeral 256 in FIG. 14), a contact pressure is applied to a transfer arm 330 at a time of measurement. Thus, the gap cannot be accurately measured. Further, as in conventional example 2, measurement with a wide span cannot be made.

In the method of using the gap gauge 254 in conventional example 4 (refer to FIG. 13), whether or not the gap gauge 254 contacts a reference plate or a reference wafer is checked visually or by human senses. Thus, the gap cannot be accurately measured.

In the adjustment using the upper and lower probes 271A and 271B and the electrical resistance measuring unit 272 in conventional example 6 (refer to FIG. 15), the wafer 220E is inserted between the upper and lower probes 271A and 271B in such a manner that the wafer 220E does not contact the probes 271A and 271B. Thus, the contact between the wafer 220E and one of the probes 271A and 271B cannot be avoided. Due to the contact, the one of the probes 271A and 271B may be deviated, so that the gap may be varied. Further, installation of the upper and lower probes 271A and 271B, which is the most important to obtain accuracy, and adjustment when the deviation occurs are considered to be difficult.

It is a main challenge of the present invention to allow teaching of the height of a carrier stage relative to a transfer arm to be performed with high accuracy.

According to a first aspect of the present invention, there is provided a teaching device used when teaching of the height of a carrier stage relative to a transfer arm in a transfer system is performed. The transfer system includes the transfer arm that transfers a wafer and the carrier stage with a carrier that holds the wafer mounted thereon. The teaching device includes:

a teaching jig including a disc arranged on a slot base in the carrier and a head member attached to the disc, the head member having a projecting portion designed to be located within an optimal gap between the disc and the transfer arm below the disc; and

a detector that detects electrical contact between the projecting portion and the transfer arm.

According to a second aspect of the present invention, there is provided a teaching device used when teaching of the height of a carrier stage relative to a transfer arm in a transfer system is performed. The transfer system includes the transfer arm that transfers a wafer and the carrier stage with a carrier that holds the wafer mounted thereon. The teaching device includes:

a disc arranged on a slot base in the carrier;

a teaching jig mounted on the transfer arm and having a projecting portion designed to be located within an optimal gap between the disc and the transfer arm below the disc arranged on the slot base; and

a detector that detects electrical contact between the projecting portion and the disc.

According to a third aspect of the present invention, there is provided a teaching method of teaching the height of a carrier stage relative to a transfer arm in a transfer system. The transfer system includes the transfer arm that transfers a wafer and a carrier stage with a carrier that holds the wafer mounted thereon. The teaching method includes:

moving the carrier stage so that the transfer arm is located below a slot in a predetermined stage of the carrier;

extending the transfer arm into the carrier to connect a first clip to the transfer arm;

arranging a teaching jig on a slot base associated with the slot in the predetermined stage of the carrier to connect a second clip to the teaching jig, the teaching jig having a projecting portion on a disc and being arranged on the slot base with the projecting portion pointed downward;

connecting wirings respectively associated with the first clip and the second clip to a detector; and

raising or lowering the carrier stage to detect an electrical contact switching position between the projecting portion and the transfer arm by the detector.

According to a fourth aspect of the present invention, there is provided a teaching method of teaching the height of a carrier stage relative to a transfer arm in a transfer system. The transfer system includes the transfer arm that transfers a wafer and the carrier stage with a carrier that holds the wafer mounted thereon. The teaching method includes:

moving the carrier stage so that the transfer arm is located below a slot in a predetermined stage of the carrier;

extending the transfer arm into the carrier to mount a teaching jig on the transfer arm, thereby connecting a first clip to the teaching jig, the teaching jig having a projecting portion and being mounted with the projecting portion pointed upward;

arranging a disc on a slot base associated with the slot in the predetermined stage of the carrier, thereby connecting a second clip to the disc;

connecting wirings respectively associated with the first clip and the second clip to a detector; and

raising or lowering the carrier stage to detect an electrical contact switching position between the projecting portion and the disc by the detector.

The meritorious effects of the present invention are summarized as follows.

According to the present invention, the optimal gap in terms of design is ensured by the mechanical component (teaching jig). Then, by detecting the electrical contact between the transfer arm and the teaching jig, teaching is performed. High-accuracy teaching can be thereby implemented without depending on human senses (vision, hearing, and touch). Further, no skill is needed for the operation, and any one can perform teaching in a short time. Further, reliability of the accuracy of the teaching jig can be ensured for a long time, and checking and calibration of the accuracy is facilitated. In addition, a measurement unit is small-sized and can make measurement over a wide span within the carrier. Further, the system can be configured at low cost without needing an additional measuring device. Moreover, a preparation for a power supply or the like is not needed, and the teaching device can be used, irrespective of a working environment. In addition, accurate measurement can be made without contact pressure applied at a time of the measurement.

### BRIEF DESCRIPTIONS OF THE DRAWINGS

FIG. 1 is a schematic diagram showing an example of use of a teaching device according to a first exemplary embodiment of the present invention:

FIG. 2 includes a front view and a plan view schematically showing a configuration of a teaching jig in the teaching device according to the first exemplary embodiment of the present invention;

FIG. 3 includes a front view and a sectional view schematically showing a configuration of a disc of the teaching jig in the teaching device according to the first exemplary embodiment of the present invention;

FIG. 4 is an enlarged front view schematically showing a configuration of a head member of the teaching jig in the teaching device according to the first exemplary embodiment of the present invention;

FIG. 5 is a schematic diagram for explaining a reference gap between a wafer and a transfer arm;

FIG. 6 is a flowchart schematically showing a teaching method that uses the teaching device according to the first exemplary embodiment of the present invention;

FIG. 7 includes a plan view, a sectional view taken along a line X-X′, a sectional view taken along a line Y-Y′ of a calibration jig used when the teaching jig in the teaching device according to the first exemplary embodiment of the present invention is calibrated;

FIG. 8 is a schematic diagram showing an example of use of the calibration jig used when the teaching jig in the teaching device according to the first exemplary embodiment of the present invention is calibrated;

FIG. 9 is a schematic diagram showing an example of use of a teaching device according to a second exemplary embodiment of the present invention;

FIG. 10 is a schematic diagram for explaining a teaching method according to conventional art 1;

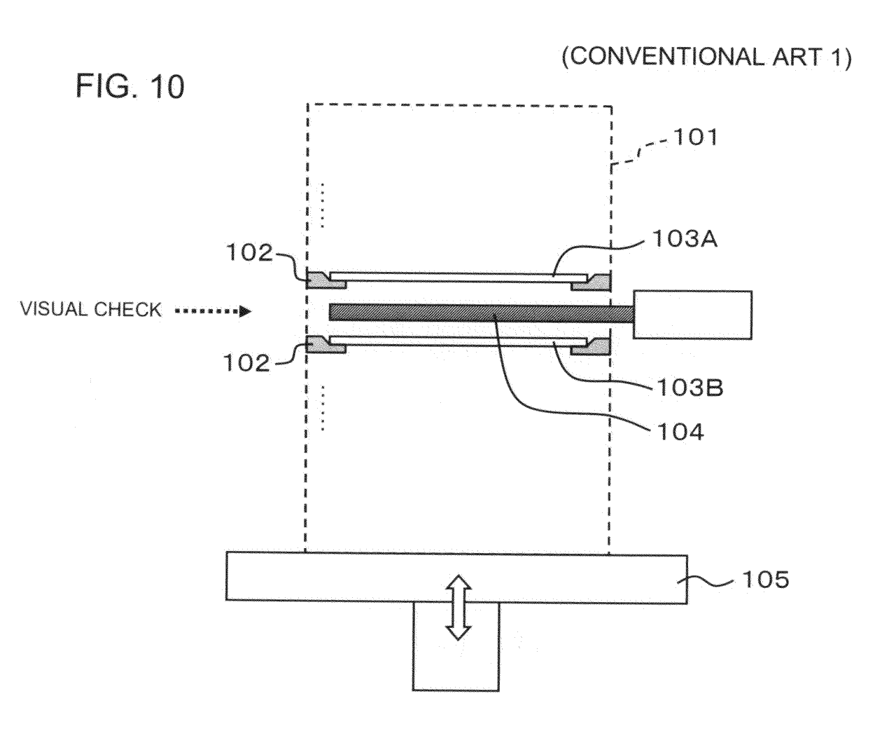

FIG. 11 is a schematic diagram for explaining a teaching method according to conventional art 2;

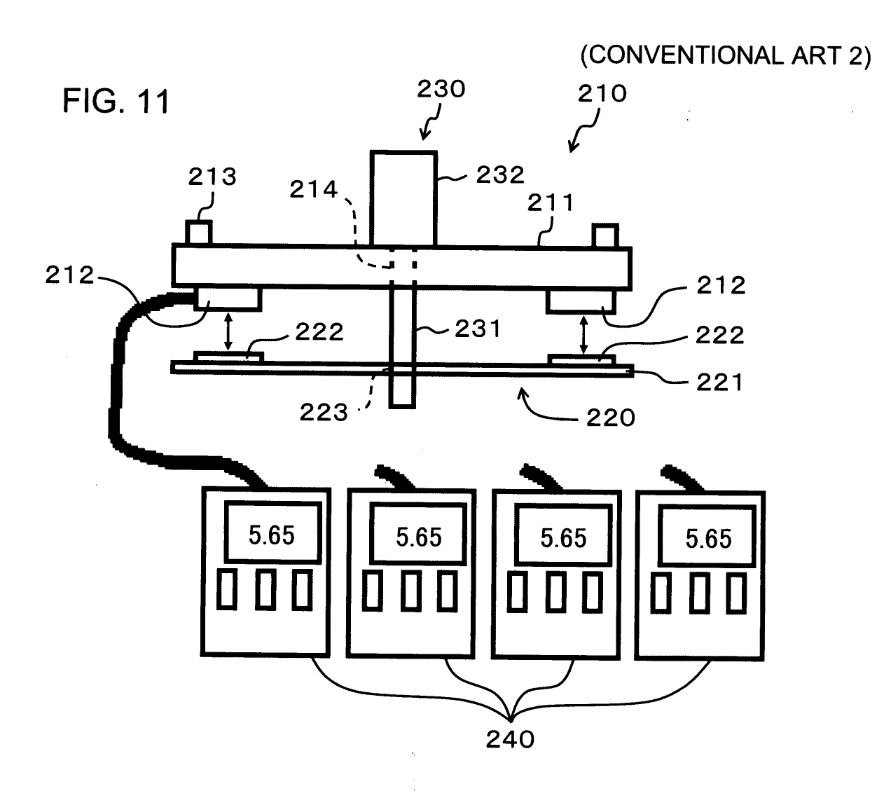

FIG. 12 is a schematic diagram for explaining a teaching method according to conventional art 3;

FIG. 13 is a schematic diagram for explaining a teaching method according to conventional art 4;

FIG. 14 is schematic diagram for explaining a teaching method according to conventional art 5; and

FIG. 15 schematic diagram for explaining a teaching method according to conventional art 6.

### PREFERRED MODES OF THE INVENTION

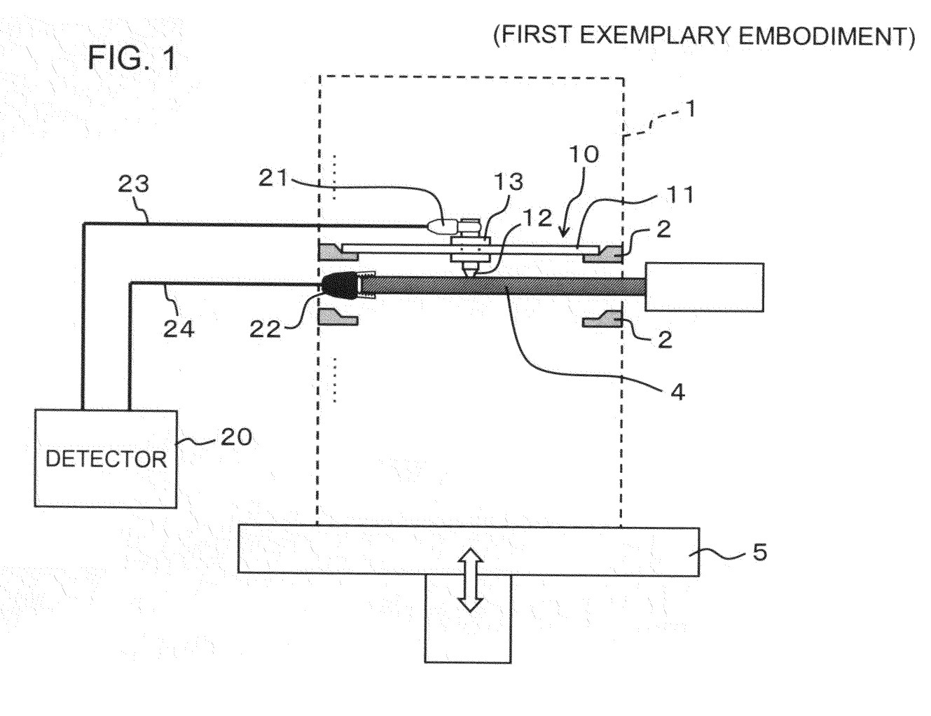

According to an exemplary embodiment of the present invention, there is provided a teaching device used when teaching of the height of a carrier stage (indicated by reference numeral 5 in FIG. 1) relative to a transfer arm (indicated by reference numeral 4 in FIG. 1) in a transfer system is performed. The transfer system includes the transfer arm (indicated by reference numeral 4 in FIG. 1) that transfers a wafer and the carrier stage on which a carrier (indicated by reference numeral 1 in FIG. 1) that holds the wafer is mounted. The teaching device includes a teaching jig (indicated by reference numeral 10 in FIG. 1) and a detector (indicated by reference numeral 20 in FIG. 1). The teaching jig includes a disc (i.e., circular plate) (indicated by reference numeral 11 in FIG. 1) arranged on a slot base (indicated by reference numeral 2 in FIG. 1) in the carrier (indicated by reference numeral 1 in FIG. 1) and a head member (indicated by reference numeral 12 in FIG. 1) attached to the disc (indicated by reference numeral 11 in FIG. 1). The head member has a projecting portion designed to be located within an optimal gap between the transfer arm (indicated by reference numeral 4 in FIG. 1) arranged below the disc (indicated by reference numeral 11 in FIG. 1) and the disc (indicated by reference numeral 11 in FIG. 1). The detector detects electrical contact between the projecting portion and the transfer arm (indicated by reference numeral 4 in FIG. 1).

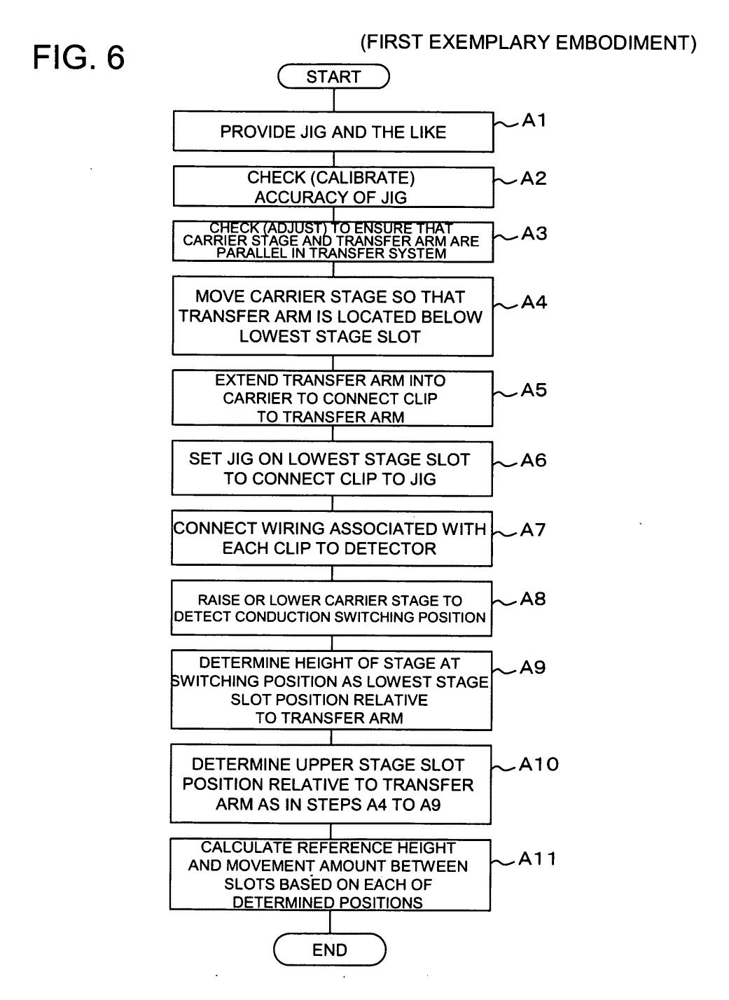

In a teaching method according to the exemplary embodiment of the present invention, teaching of the height of a carrier stage relative to a transfer arm in a transfer system is performed. The transfer system includes the transfer arm that transfers a wafer and the carrier stage with a carrier that holds the wafer mounted thereon. The method includes: a step (step A4 in FIG. 6) of moving the carrier stage so that the transfer arm is located below a slot in a predetermined stage of the carrier; a step (step A5 in FIG. 6) of extending the transfer arm into the carrier to connect a first clip to the transfer arm; a step (step A6 in FIG. 6) of arranging a teaching jig on a slot base associated with the slot in the predetermined stage of the carrier to connect a second clip to the teaching jig, the teaching jig having a projecting portion on a disc and being arranged on the slot base with the projecting portion pointed downward; a step (step A7 in FIG. 6) of connecting wirings associated with the first and second clips to a detector; and a step (step A8 in FIG. 6) of raising or lowering the carrier stage to detect an electrical contact switching position between the projecting portion and the transfer arm by the detector.

### First Exemplary Embodiment

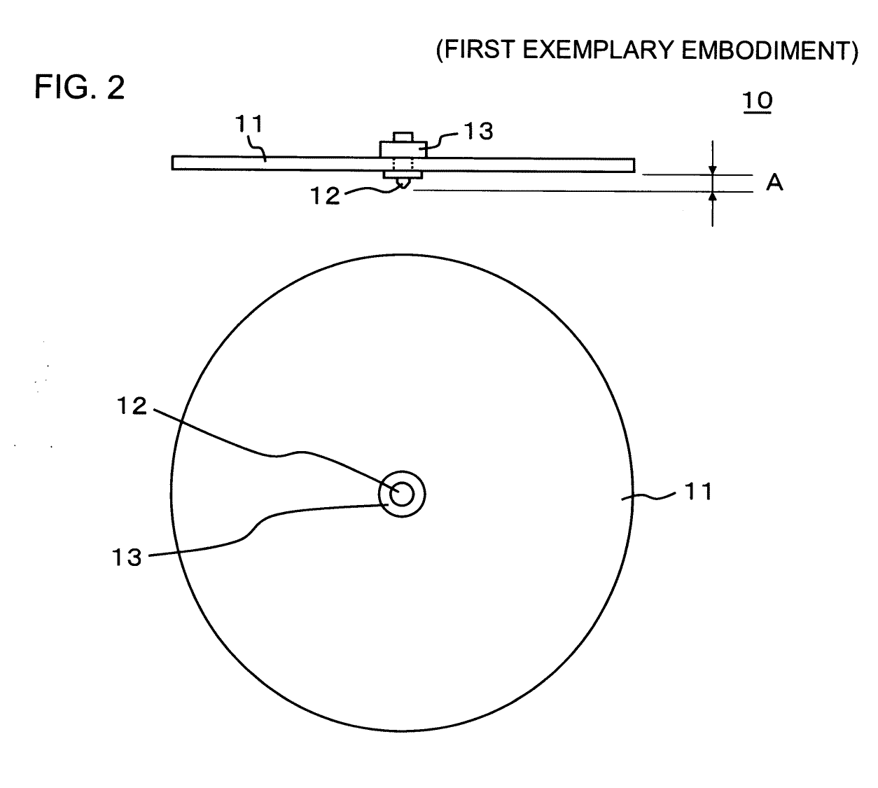

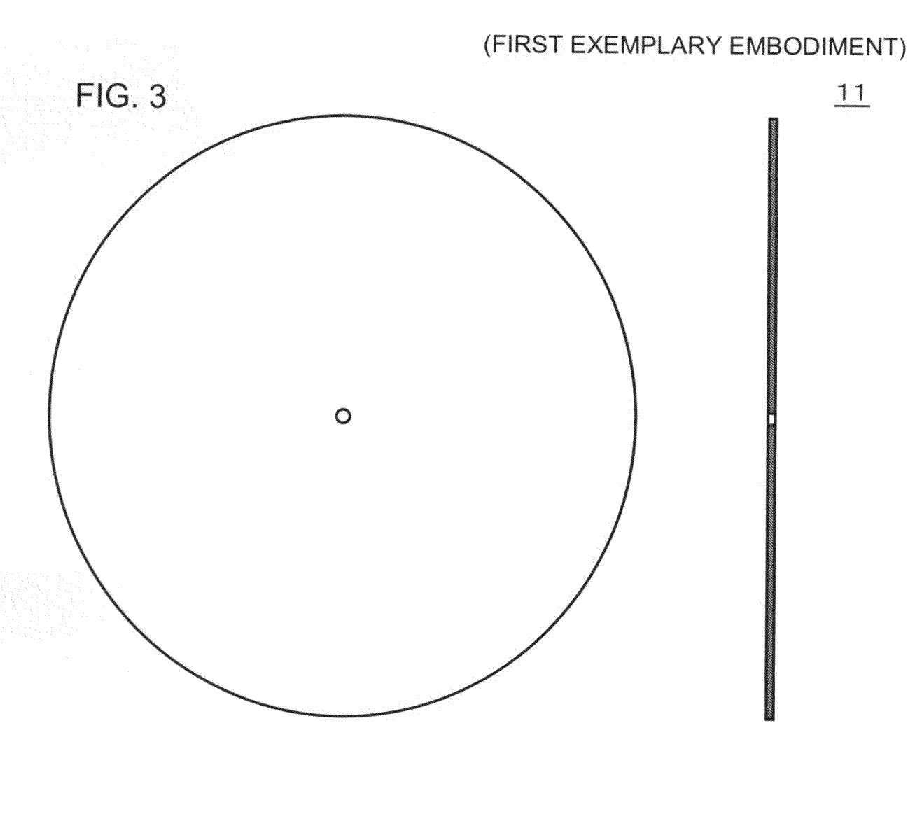

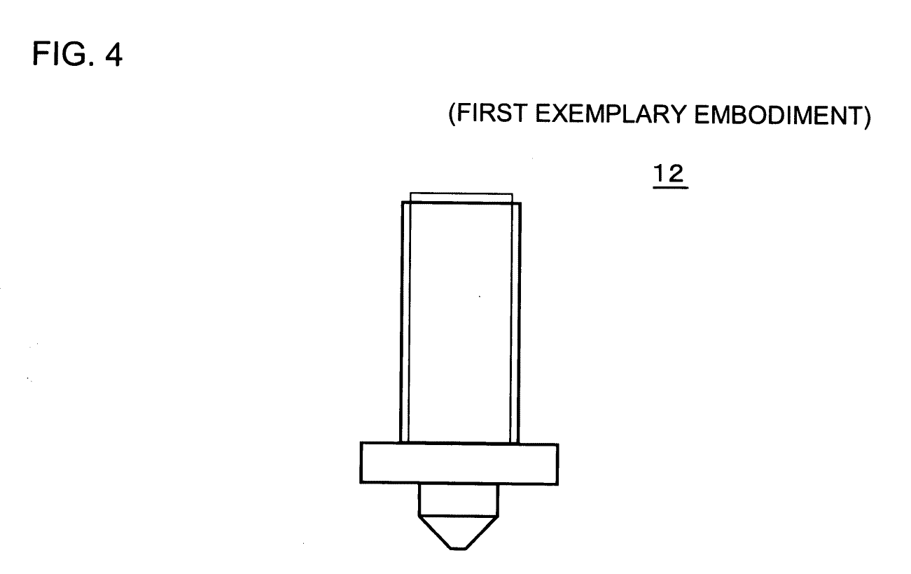

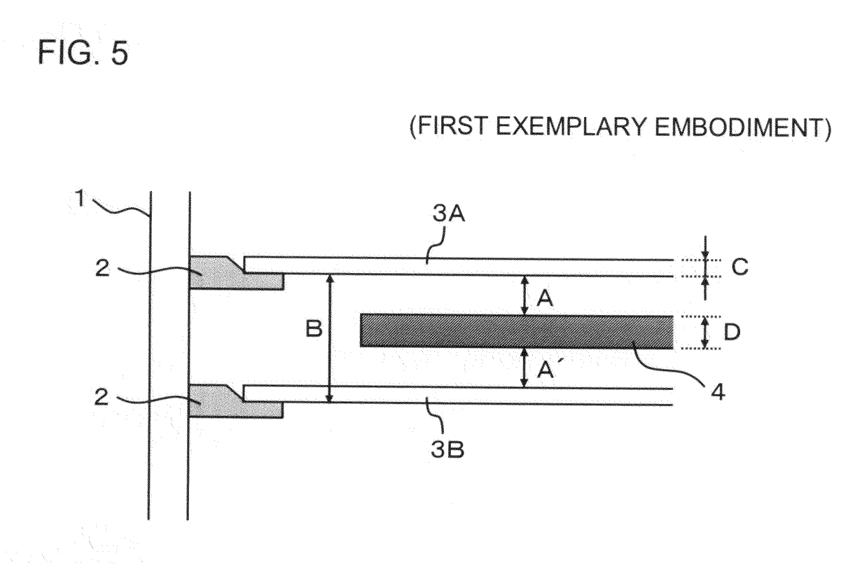

A teaching device according to a first exemplary embodiment of the present invention will be described using drawings. FIG. 1 is a schematic diagram showing an example of use of the teaching device according to the first exemplary embodiment of the present invention. FIG. 2 includes a front view and a plan view schematically showing a configuration of a teaching jig in the teaching device according to the first exemplary embodiment of the present invention. FIG. 3 includes a plan view and a sectional view schematically showing a configuration of a disc of the teaching jig in the teaching device according to the first exemplary embodiment of the present invention. FIG. 4 is an enlarged front view schematically showing a configuration of a head member of the teaching jig in the teaching device according to the first exemplary embodiment of the present invention. FIG. 5 is a schematic diagram for explaining a reference gap between a wafer and a transfer arm.

Referring to FIG. 1, the teaching device is the device that is used when teaching of the height of a carrier stage 5 relative to a transfer arm 4 in a transfer system is performed. The transfer system includes the transfer arm 4 and the carrier stage 5 on which a carrier 1 is mounted. The teaching device is used for causing a computer (not shown) that controls the transfer system to learn a positional relationship between the transfer arm 4 and each slot in the carrier 1 so that when a wafer (not shown) is transferred into the carrier 1 by the transfer arm 4, the transfer arm 4 that holds the wafer (not shown) does not contact a slot base 2 or another wafer already held in the slot. The height of the carrier stage 5 relative to the transfer arm 4 is detected based on whether or not a projecting portion of a head member 12 on a lower portion of a teaching jig 10 comes into contact with the transfer arm 4 (leading end portion of the transfer arm 4 that enters into the carrier 1) to conduct electricity.

The carrier 1 is a holder for holding a plurality of wafers so that the wafers may be inserted into and removed from the carrier 1 by the transfer arm 4, and is mounted on the carrier stage 5. On an inner wall of the carrier 1, the slot base 2 in the shape of a projection is provided for each slot (space where one wafer is held) at a predetermined interval in order to hold the wafers in a laminated state.

The transfer arm 4 is an arm for transferring a wafer. The transfer arm 4 has a function of holding the wafer and has a function of moving the wafer in three (lateral, vertical, and to-and-fro) directions. The transfer arm 4 can enter into or exit from the carrier 1 with its predetermined height maintained. At least a portion of the transfer arm 4 that enters into the carrier 1 is made of a conductive material. When teaching is performed, the transfer arm 4 is caught by a clip 22, and is electrically connected to a detector 20 through the clip 22, and a wiring (connecting line) 24. An operation of the transfer arm 4 is controlled by the computer not shown.

The carrier stage 5 is a stage for mounting the carrier 1 thereon, and has a function of moving vertically. An operation of the carrier stage 5 is controlled by the computer not shown.

The teaching jig 10 is formed of a disc 11, the head member 12, and a nut 13 (refer to FIG. 2). When mounted on the slot base 2 in the carrier 1, the projecting portion of the head member 12 of the teaching jig 10 is arranged pointed downward.

The disc 11 is a member in the form of a disk capable of being mounted on each slot base 2 in the carrier 1 (refer to FIGS. 1 to 3). In the center of the disc 11, a through hole for passing an axial portion of the head member 12 is formed.

The head member 12 is a member made of a conductive material and having the projecting portion at its bolt head section. A thread groove is formed in the bolt axis portion of the head member 12. The bolt axis portion is passed through the through hole of the disc 11, and a leading end part of the bolt axis portion that has been passed through the through hole screws into the nut 13. The leading end part of the bolt axis portion of the head member 12 is caught by a clip 21 when teaching is performed, and is electrically connected to the detector 20 through the clip 21 and a wiring 23. A leading end part of the projecting portion of the head member 12 is a contact portion for detecting whether or not the leading end part comes into contact with the transfer arm 4 (leading end portion of the transfer arm 4 that enters into the carrier 1) to conduct electricity. The height of the projecting portion of the head member 12 is set so that a spacing between the undersurface of the wafer in the carrier 1 (corresponding to the undersurface of the disc 11) and the transfer arm 4 is an optimal gap (reference gap A). The reference gap A can be obtained using a computing expression of “A=(B−C−D)/2=A′” when a wafer interval is indicated by B, a wafer thickness is indicated by C, and an arm thickness is indicated by D, as shown in FIG. 5.

The nut 13 is a member that screws on the bolt axis portion of the head member 12 (refer to FIGS. 1 and 2). The nut 13 screws on the bolt axis portion of the head member 12 on a surface of the disc 11 opposite to the surface on the side of the projecting portion of the head member 12.

The detector 20 is a device for detecting electrical contact between the teaching jig 10 and the transfer arm 4 (leading end portion of the transfer arm 4 that enters into the carrier 1). A tester, for example, may be used as the detector 20. When testing is performed, the detector 20 is electrically connected to the head member 12 (leading end part of the bolt axis portion) of the teaching jig 10 through the wiring 23 and the clip 21, and is electrically connected to the transfer arm 4 (leading end portion that enters into the carrier 1) through the wiring 24 and the clip 22. The detector 20 has a notification function using a sound or a display when the teaching jig 10 comes into contact with the transfer arm 4.

Herein, the teaching device is assumed to be applied to the field of semiconductors. The teaching device may also be applied to a field other than the field of semiconductors.

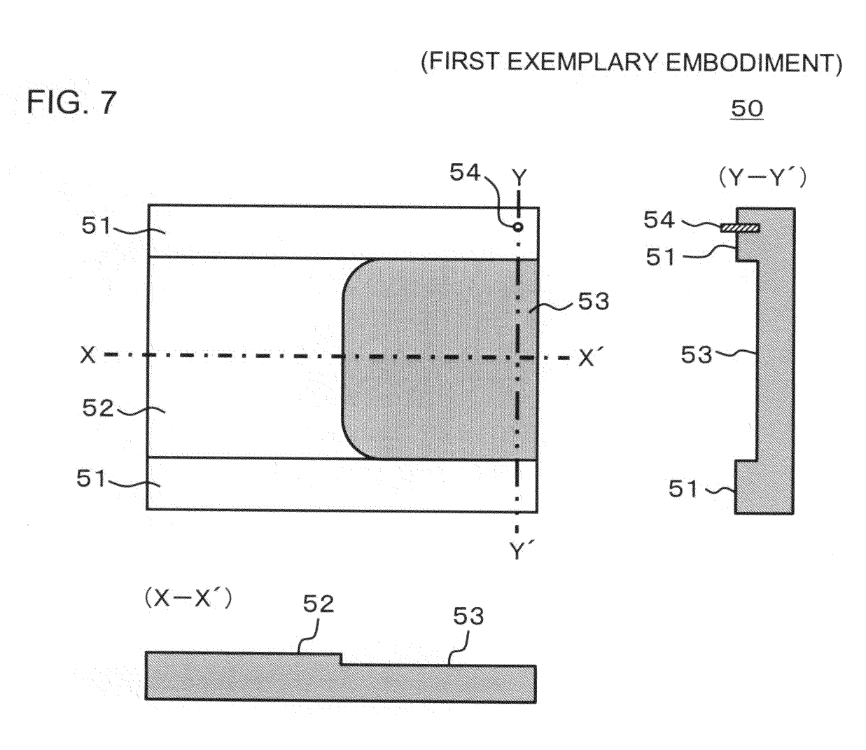

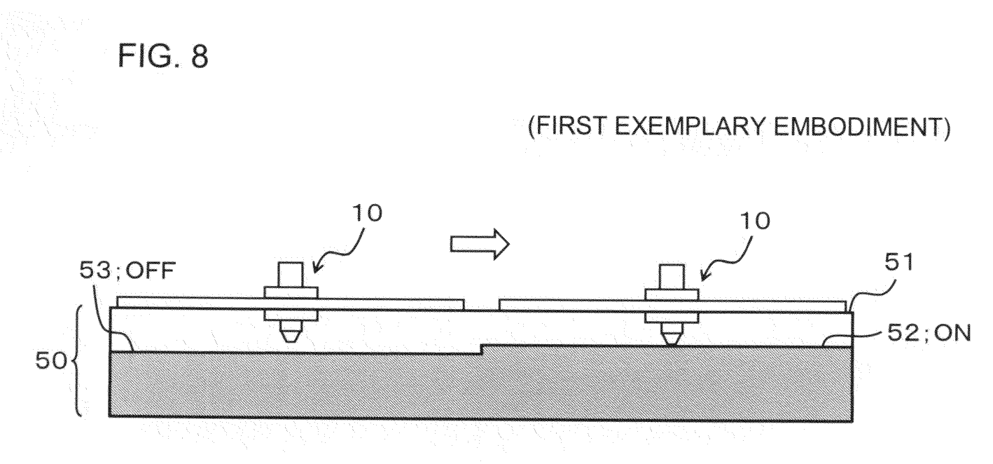

Next, a teaching method that uses the teaching device according to the first exemplary embodiment of the present invention will be described using drawings. FIG. 6 is a flowchart schematically showing the teaching method that uses the teaching device according to the first exemplary embodiment of the present invention. FIG. 7 includes a top plan view of a calibration jig used when the teaching jig in the teaching device in the first exemplary embodiment of the present invention is calibrated, a sectional view of the calibration jig taken along a line X-X′, and a sectional view of the calibration jig taken along a line Y-Y′. FIG. 8 is a schematic diagram showing an example of use of the calibration jig used when the teaching jig in the teaching device in the first exemplary embodiment of the present invention is calibrated.

Referring to FIG. 6, the teaching jig (indicated by reference numeral 10 in FIG. 1), detector (indicated by reference numeral 20 in FIG. 1), and wirings (indicated by reference numerals 23 and 24 in FIG. 1) with clips (indicated by reference numerals 21 and 22 in FIG. 1) corresponding to the carrier (indicated by reference numeral 1) of the transfer system targeted for teaching are provided, as an advance preparation (in step A1). A performance check (0 point check and battery check) on the detector (indicated by reference numeral 20 in FIG. 1) to be used is made, thereby confirming that there is no abnormality.

Next, in order to maintain the accuracy of teaching, the accuracy of the teaching jig (indicated by reference numeral 10 in FIG. 1) is checked before use (in step A2). When it is found that the teaching jig has the desired accuracy, the operation proceeds to step A3. When it is found that the teaching jig does not have the desired accuracy, the teaching jig (indicated by reference numeral 10 in FIG. 1) is calibrated using the calibration jig (indicated by reference numeral 50 in FIG. 7), and the accuracy of the teaching jig is checked again.

In the calibration jig 50, base portions 51 are formed on edge portions of two sides of a rectangular plate member made of a conductive material. Grooves with an elevational difference are formed between the base portions 51. A groove with a shallow bottom surface functions as an ON region 52 (with a depth of the reference gap A−0.05 mm, e.g.), while a groove with a deep bottom surface functions as an OFF region 53 (with a depth of the reference gap A+0. 02 mm, e.g.).

When the teaching jig (indicated by reference numeral 10 in FIG. 1) is calibrated, the teaching jig 10 is placed on the base portion 51 as shown in FIG. 8, and it is checked that the teaching jig 10 does not conduct electricity in the OFF region 52, but conducts electricity in the ON region 52, thereby conforming that the teaching jig 10 is within a predetermined range (of 0.02 mm to −0.05 mm of reference dimensions H, e.g.). On this occasion, the clip (indicated by reference numeral 21 in FIG. 1, for example) is connected to the teaching jig 10 and the clip (indicated by reference numeral 22 in FIG. 1, for example) is connected to a terminal portion 54 of the calibration jig 50, thereby electrically connecting the detector (indicated by reference numeral 20 in FIG. 1, for example) to both of the clips through the wirings (indicated by reference numerals 23 and 24 in FIG. 1, for example). Further, in order to avoid influence of dirt and foreign matter, reference surfaces of the teaching jig 10 and the calibration jig 50 are wiped by a low dust wiper immersed in a chemical for maintenance. The detector (indicated by reference numeral 20 in FIG. 1, e.g., the tester) is set to a resistance range. Then, after it has been confirmed that the teaching jig 10 does not conduct electricity (with ∞Ω) in the OFF region 53, the teaching jig 10 is moved to the ON region 52, and then it is confirmed that the teaching jig 10 conducts electricity (with a resistance of not more than 10Ω, for example) in the ON region 52. When the teaching jig 10 conducts electricity in the OFF region 53 or when the teaching jig 10 does not conduct electricity in the ON region 52, predetermined measures are taken to perform a similar check again. As the predetermined measures, when the teaching jig 10 does not conduct electricity in either of the OFF region 53 and the ON region 52, a spacer in the form of a ring (not shown: e.g., a spacer with a thickness of 0.02 mm) is interposed between the bolt head section of the head member (indicated by reference 12 in FIG. 1) and the disc 11 in the teaching jig 10 to make adjustment. When the teaching jig 10 conducts electricity in both of the OFF region 53 and the ON region, the spacer is replaced with a thinner spacer, the number of the spacers is reduced, or the spacer is removed to make adjustment.

Next, it is checked whether or not the carrier stage (indicated by reference numeral 5 in FIG. 1) of the transfer system and the transfer arm (indicated by reference numeral 4 in FIG. 1) are parallel (level) with each other (in step A3). When the carrier stage and the transfer arm are parallel, the operation proceeds to step A4. When the carrier stage and the transfer arm are not parallel, inclinations of the carrier stage (indicated by reference numeral 5 in FIG. 1) and the transfer arm (indicated by reference numeral 4 in FIG. 1) are adjusted to perform the check again.

Next, the carrier stage (indicated by reference numeral 5 in FIG. 1) is moved so that the transfer arm (indicated by reference numeral 4 in FIG. 1) is located below a slot in the lowest stage in the carrier (indicated by reference numeral 1 in FIG. 1) (in step A4).

Next, the transfer arm (indicated by reference numeral 4 in FIG. 1) is extended into the carrier (indicated by reference numeral 1 in FIG. 1) to connect the clip (indicated by reference numeral 22 in FIG. 1) to the transfer arm (indicated by reference numeral 4 in FIG. 1) (in step A5).

Next, the teaching jig (indicated by reference numeral 10 in FIG. 1) is set on the slot base (indicated by reference numeral 2 in FIG. 1) associated with the slot in the lowest stage in the carrier (indicated by reference numeral 1 in FIG. 1), and the clip (indicated by reference numeral 21 in FIG. 1) is connected to the teaching jig (indicated by reference numeral 10 in FIG. 1) (in step A6).

Next, the wirings (indicated by reference numerals 23 and 24 in FIG. 1) associated with the respective clips (indicated by reference numerals 21 and 22 in FIG. 1) are connected to the detector (indicated by reference numeral 20 in FIG. 1; tester or the like) (in step A7).

Next, by gradually raising or lowering the carrier stage (indicated by reference numeral 5 in FIG. 1), a conduction (electrical contact) switching point across the transfer arm (indicated by reference numeral 4 in FIG. 1) and the teaching jig (indicated by reference numeral 10 in FIG. 1) is checked (in step A8). The projecting portion of the head member (indicated by reference numeral 12 in FIG. 1) of the teaching jig (indicated by reference numeral 10 in FIG. 1) is set to provide an optimal gap for teaching in step A2. Thus, by detecting conduction (electrical contact) across the transfer arm (indicated by reference numeral 4 in FIG. 1) and the teaching jig (indicated by reference numeral 10 in FIG. 1), teaching of the optical height of the carrier stage (indicated by reference numeral 5 in FIG. 1) relative to the transfer arm (indicated by reference numeral 4 in FIG. 1) can be performed.

Next, the height of the carrier stage (indicated by reference numeral 5 in FIG. 1) at the detected switching point is determined as the position of the slot in the lowest stage relative to the transfer arm (indicated by reference numeral 4 in FIG. 1) (in step A10).

Next, a procedure that is the same as steps A3 to A9 is performed, and the height of the carrier stage (indicated by reference 5 in FIG. 1) at the detected switching point relative to a slot in an upper stage (slot capable of obtaining a widest possible span) is determined as the position of the slot relative to the transfer arm (4 in FIG. 1) (in step A10).

Finally, based on the positions determined in steps A9 and A10, a reference height and a movement amount between the slots are calculated (in step A11), and the operation is finished.

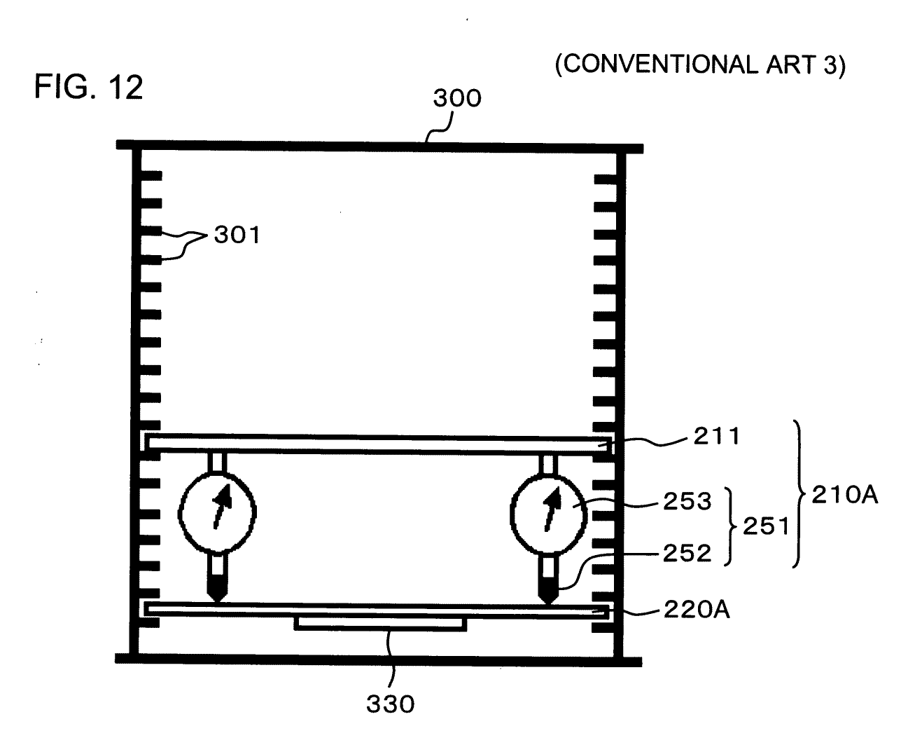

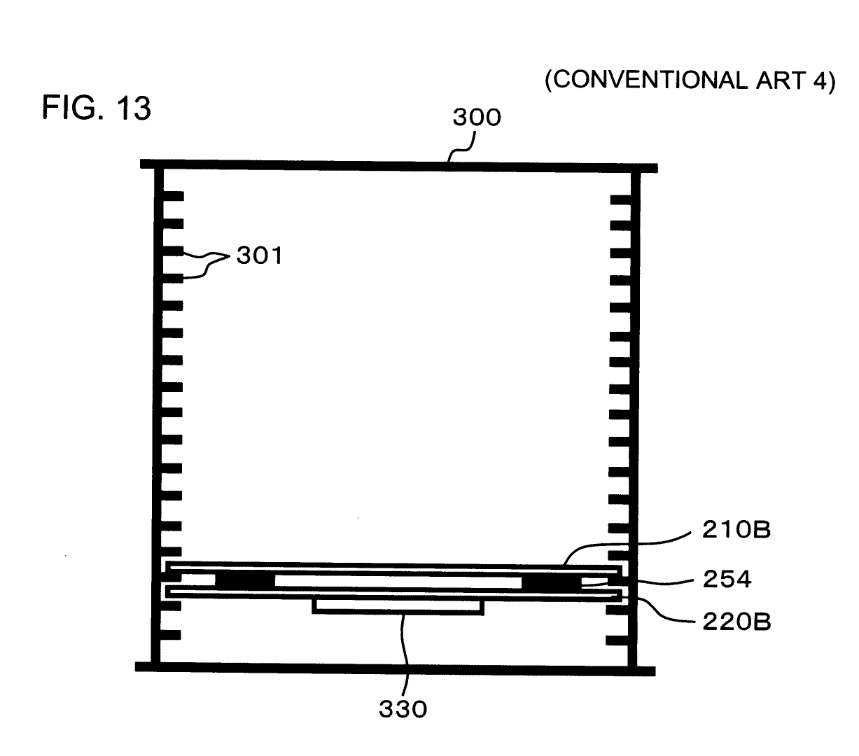

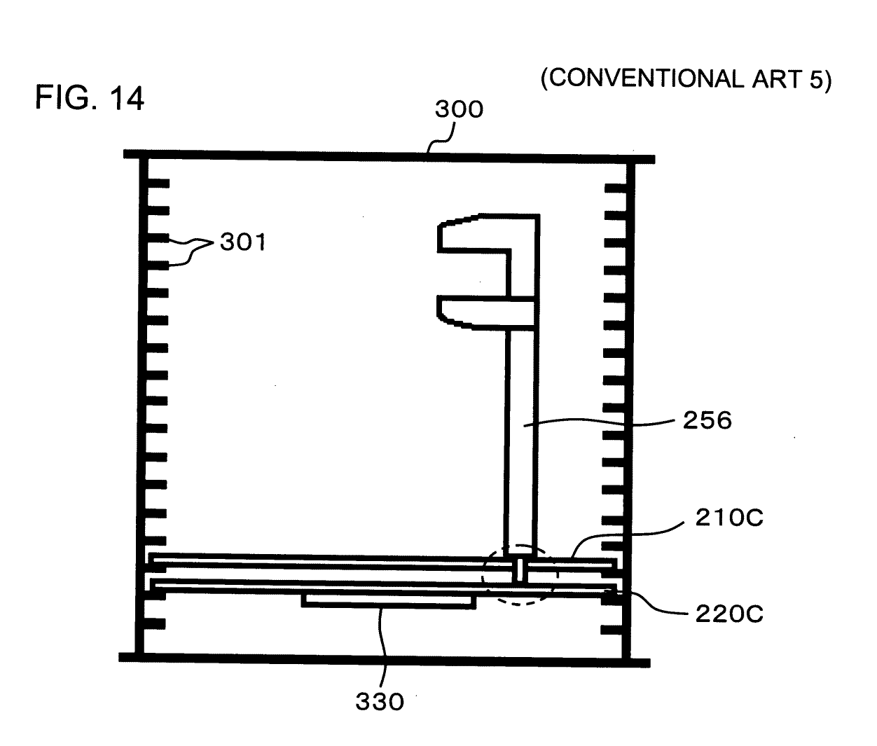

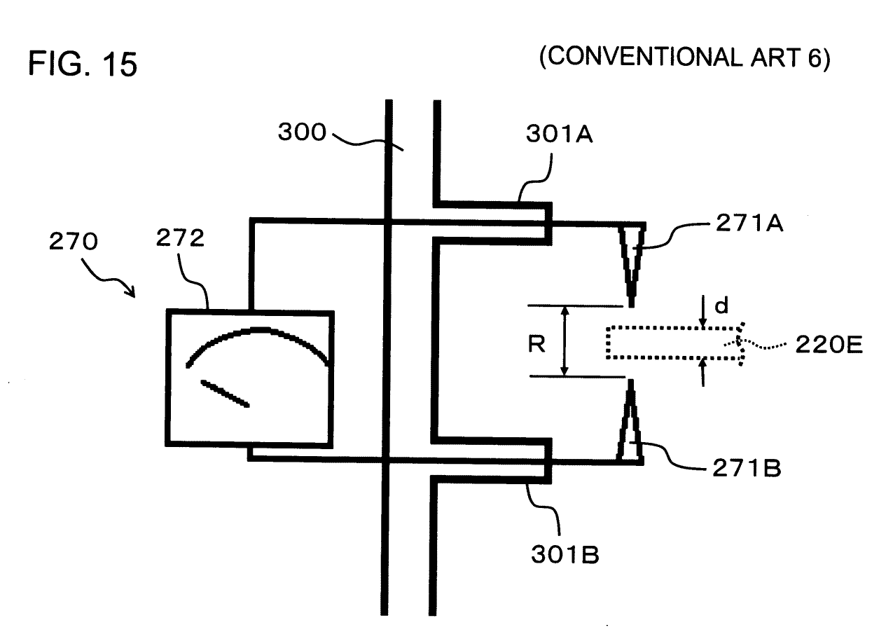

According to the first exemplary embodiment, an optimal gap (reference gap) necessary for teaching is detected by conduction (electrical contact) using the teaching jig 10 having the projecting portion rather than measurement. Thus, the measurement is not needed, and high-accuracy teaching can be performed. For this reason, the high-accuracy teaching can be implemented without depending on human senses (vision, hearing, and touch). The teaching accuracy is higher than in the case where a gap gauge is used as in a conventional art 4 (refer to FIG. 13). Further, the contact point is electrically clarified, measurement accuracy reduction due to a contact pressure, which is a problem when a dial gauge or a vernier caliper is used as in conventional art 3 or 5 (refer to FIGS. 12 and 14) does not occur. Further, there is no gap variation due to a deviation of a probe at a time of adjustment, which is a problem when the probe and an electrical resistance measuring unit are used as in conventional art 6 (refer to FIG. 15). Thus, reliability of the accuracy of the jig can be ensured for a long period.

Further, no skill is needed for the operation, and any one can perform teaching in a short time. Further, reliability of the accuracy of the teaching jig 10 can be ensured for a long time, and checking and calibration of the accuracy is facilitated. In addition, a measurement unit is small-sized and can make measurement over a wide span within the carrier 1. Further, the system can be configured at low cost without needing an additional measuring device. Further, a preparation for a power supply or the like is not needed, and the teaching device can be used, irrespective of a working environment. In addition, accurate measurement can be made without contact pressure applied at a time of the measurement.

### Second Exemplary Embodiment

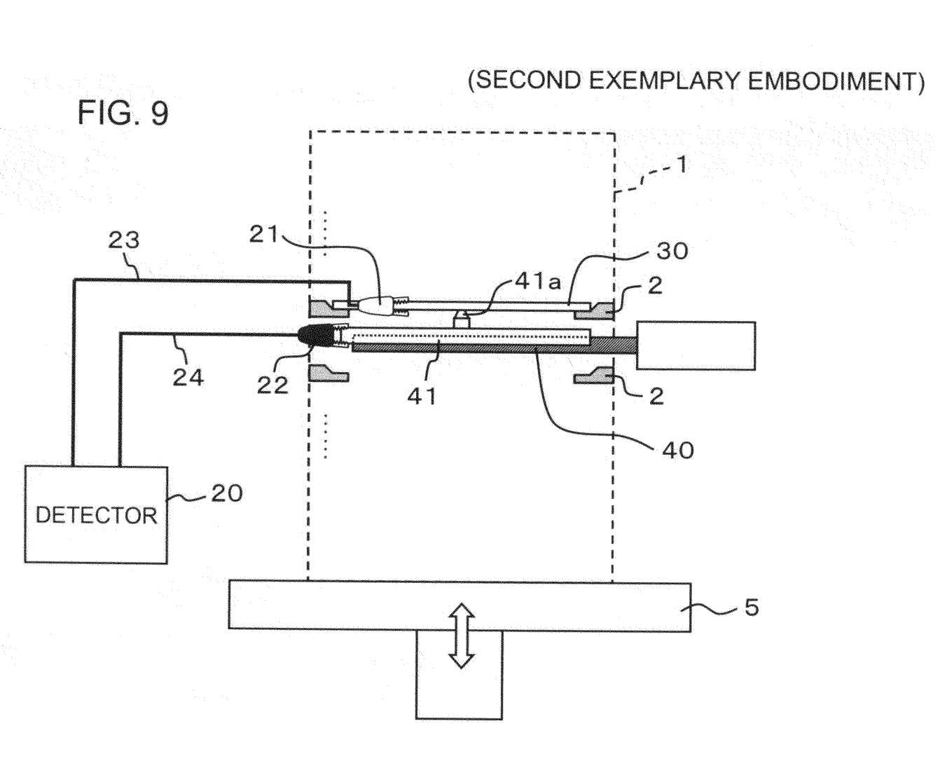

A teaching device according to a second exemplary embodiment of the present invention will be described using drawings. FIG. 9 is a schematic diagram showing an example of use of the teaching jig according to the second exemplary embodiment of the present invention.

The teaching device according to the second exemplary embodiment is obtained by mounting a teaching jig 41 including a projecting portion 41a on a transfer arm 40 (by placing the teaching jig 41 on the transfer arm 40). The teaching jig 41 does not necessarily need to be fixed to the transfer arm 40.

The transfer arm 40 is an arm for transferring a wafer. The transfer arm 40 has a function of holding the wafer and has a function of moving the wafer in three (lateral, vertical, and to-and-fro) directions. The transfer arm 40 can enter into or exit from the carrier 1 with its predetermined height maintained. An operation of the transfer arm 40 is controlled by the computer not shown. The transfer arm 40 is different from the transfer arm (indicated by reference numeral 4 in FIG. 1). It does not matter whether a portion of the transfer arm 40 that enters into the carrier 1 is formed of a conductive material or not.

The teaching jig 41 is mounted on the transfer arm 40 so that the teaching jig 41 covers the transfer arm 40 from above. The teaching jig 40 is a member having a projecting portion 41a on the central portion of its upper surface, and formed of a conductive material. When teaching is performed, the portion of the teaching jig 41 that covers the transfer arm 40 is caught by a clip 22 and is electrically connected to a detector 20 through a wiring 24. A leading end part of the projecting portion 41a is a contact portion for detecting whether or not the leading end part comes into contact with a disc 30 to conduct electricity. The height of the projecting portion 41a is set so that a spacing between the undersurface of the wafer in the carrier 1 (corresponding to the undersurface of the disc 30) and the transfer arm 40 is an optimal gap (reference gap A). The reference gap A is set to “A=(B−C−D)/2=A′” (refer to FIG. 5).

The disc 30 is a plate member in the form of a disk capable of being mounted on each slot base 2 in the carrier 1. The disc 30 is formed of a conductive material, and is caught by a clip 21 when teaching is performed. The disc 30 is electrically connected to the detector 20 through the clip 21 and a wiring 23. If the transfer arm 40 is conductive, the disc 30 needs to be insulated from slot bases 2 or the carrier 1.

Other configurations and operation are the same as those in the first exemplary embodiment. However, in order to ensure accuracy, it is important to set the weight of the teaching jig 41 mounted on the transfer arm 40 to be comparable or not more than the weight of the wafer, thereby reducing a deviation of the transfer arm 40 in a downward direction due to the load on the transfer arm 40.

According to the second exemplary embodiment, even when the material used in the transfer arm 40 (portion that enters into the carrier 1) is a non-conductive material such as ceramics as well as the conductive material, high-accuracy teaching can be performed as in the first exemplary embodiment.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A teaching device used when teaching of height of a carrier stage relative to a transfer arm in a transfer system is performed, the transfer system including the transfer arm that transfers a wafer and the carrier stage with a carrier that holds the wafer mounted thereon, the teaching device comprising:
a teaching jig including a disc arranged on a slot base in the carrier and a head member attached to the disc, the head member having a projecting portion designed to be located within an optimal gap between the disc and the transfer arm below the disc; and
a detector that detects electrical contact between the projecting portion and the transfer arm.

2. The teaching device according to claim 1, wherein
the disc has a through hole in the center thereof;
the head member has a bolt axis portion extending on a side opposite to the projecting portion; and
the bolt axis portion is configured to pass through the through hole and screw into a nut on a portion of the disc opposite to the projecting portion.

3. The teaching device according to claim 1, wherein
at least a portion of the transfer arm that enters into the carrier is formed of a conductive material;
the head member is formed of a conductive material; and
one terminal of the detector is electrically connected to the head member and the other terminal of the detector is electrically connected to the transfer arm.

4. The teaching device according to claim 2, wherein
at least a portion of the transfer arm that enters into the carrier is formed of a conductive material;
the head member is formed of a conductive material; and
one terminal of the detector is electrically connected to the head member and the other terminal of the detector is electrically connected to the transfer arm.

5. The teaching device according to claim 3, wherein
the one terminal of the detector is electrically connected to a leading end part of the bolt axis portion.

6. The teaching device according to claim 1, wherein
at least a portion of the transfer arm that enters into the carrier is formed of a conductive material;
the disc is formed of a conductive material and a portion of the disc in contact with the slot base is insulated;
the head member is formed of a conductive material; and
one terminal of the detector is electrically connected to the head member and the other terminal of the detector is electrically connected to the transfer arm.

7. The teaching device according to claim 2, wherein
at least a portion of the transfer arm that enters into the carrier is formed of a conductive material;
the disc is formed of a conductive material and a portion of the disc in contact with the slot base is insulated;
the head member is formed of a conductive material; and
one terminal of the detector is electrically connected to the head member and the other terminal of the detector is electrically connected to the transfer arm.

8. The teaching device according to claim 1, wherein
at least a portion of the transfer arm that enters into the carrier is formed of a conductive material;
the disc is formed of a nonconductive material;
the head member is formed of a conductive material; and
one terminal of the detector is electrically connected to the head member, and the other terminal of the detector is electrically connected to the transfer arm.

9. The teaching device according to claim 2, wherein
at least a portion of the transfer arm that enters into the carrier is formed of a conductive material;
the disc is formed of a nonconductive material;
the head member is formed of a conductive material; and
one terminal of the detector is electrically connected to the head member, and the other terminal of the detector is electrically connected to the transfer arm.

10. A teaching device used when teaching of a height of a carrier stage relative to a transfer arm in a transfer system is performed, the transfer system including the transfer arm that transfers a wafer and the carrier stage with a carrier that holds the wafer mounted thereon, the teaching device comprising:
a disc arranged on a slot base in the carrier;
a teaching jig mounted on the transfer arm and having a projecting portion designed to be located within an optimal gap between the disc and the transfer arm below the disc arranged on the slot base; and
a detector that detects electrical contact between the projecting portion and the disc.

11. The teaching device according to claim 10, wherein
the teaching jig is mounted on the transfer arm so that the teaching jig covers the transfer arm from above, and has the projecting portion on the center of an upper surface thereof.

12. The teaching device according to claim 10, wherein
each of the disc and the teaching jig is formed of a conductive material; and
one terminal of the detector is electrically connected to the disc and the other terminal of the detector is electrically connected to the teaching jig.

13. The teaching device according to claim 11, wherein
each of the disc and the teaching jig is formed of a conductive material; and
one terminal of the detector is electrically connected to the disc and the other terminal of the detector is electrically connected to the teaching jig.

14. A teaching method of teaching a height of a carrier stage relative to a transfer arm in a transfer system, the transfer system comprising the transfer arm that transfers a wafer and a carrier stage with a carrier that holds the wafer mounted thereon, the teaching method comprising:
moving the carrier stage so that the transfer arm is located below a slot in a predetermined stage of the carrier;
extending the transfer arm into the carrier to connect a first clip to the transfer arm;
arranging a teaching jig on a slot base associated with the slot in the predetermined stage of the carrier to connect a second clip to the teaching jig, the teaching jig having a projecting portion on a disc and being arranged on the slot base with the projecting portion pointed downward;
connecting wirings respectively associated with the first clip and the second clip to a detector; and
raising or lowering the carrier stage to detect an electrical contact switching position between the projecting portion and the transfer arm by the detector.
